(19) United States
(12) Patent Application Publication
(10) Pub. No.: US 2022/0029203 A1
(43) Pub. Date: Jan. 27, 2022

(54) LEAD ACID AND LEAD CARBON BATTERY

(71) Applicant: ROGERS CORPORATION, Chandler, AZ (US)

(72) Inventors: WEI WANG, WALTHAM, MA (US); BRETT KILHENNY, MYSTIC, CT (US)

(21) Appl. No.: 17/381,474

(22) Filed: Jul. 21, 2021

Related U.S. Application Data
(60) Provisional application No. 63/055,660, filed on Jul. 23, 2020.

(51) Int. Cl. H01M 10/08; H01M 4/62; H01M 4/14; H01M 50/446; H01M 4/57

(52) U.S. Cl. CPC H01M 10/08; H01M 4/623; H01M 4/625; H01M 2300/0011; H01M 50/446; H01M 4/57; H01M 4/14

(57) ABSTRACT

A lead acid or lead carbon battery includes a sealed casing including an acid and an electrode assembly. The electrode assembly includes an anode, a cathode, and a non-fibrous separator disposed between and in contact with at least a portion of both the anode and the cathode, wherein the anode, cathode, and non-fibrous separator are at least partially immersed in the acid. The anode includes an electrically conductive carbon active material, the cathode includes a lead oxide active material, and the non-fibrous separator has a thickness of about 0.005 to about 1.5 mm.

### CROSS-REFERENCE TO RELATED APPLICATIONS

This application claims priority to and the benefit of U.S. Provisional Application No. 63/055,660 filed on Jul. 23, 2020, the entire content of which is incorporated herein by reference.

### BACKGROUND

This disclosure is related to a lead acid and a lead carbon battery, electrode assemblies for lead acid and lead carbon batteries, separators for the same, and their method of manufacture.

Batteries are commonly used as energy sources. Typically, a battery includes a negative electrode and a positive electrode. Conventional, commercial lead acid batteries rely on negative electrodes (anodes) that are composed of lead metal and positive electrodes (cathodes) that are composed of lead dioxide, while lead carbon batteries typically include anodes including a carbonaceous species. The negative and positive electrodes are disposed in an electrolytic medium that can be either liquid or gel, specifically an acid electrolyte. During discharge of a battery, chemical reactions occur wherein an active positive electrode material is reduced, and active negative electrode material is oxidized. During the reactions, electrons flow from the negative electrode to the positive electrode through a load, and ions in the electrolytic medium flow between the electrodes. To prevent direct reaction of the active positive electrode material and the active negative electrode material, the electrodes are typically mechanically and electrically isolated from each other by a separator.

A non-woven absorptive glass mat (AGM) made with glass microfiber typically serves as a separator in sealed lead acid batteries. The glass mat separator has a critical role in electrolyte uptake and also provides structural characteristics to the electrode assembly. However, directly applying an AGM separator to lead carbon anodes in a lead carbon battery can negatively impact the cell level energy density and power density of the battery. It is further known that changes in the physical properties of the separator may have an impact on the quality of the filled and formed battery. The separator structure, including its fiber composition, may influence how well the separator will accept electrolyte, sustain pressure, or force on the internal cell components, and maintain energy and power density.

What is needed are lead acid and lead carbon batteries including separators that maintain one or more of the energy and power density of the battery, while also maintaining electrolyte uptake similar to or better than AGM separators.

### BRIEF SUMMARY

In an aspect, a lead acid or lead carbon battery comprises a sealed casing comprising an acid electrolyte; and an electrode assembly comprising an anode, a cathode, and a non-fibrous separator disposed between and in contact with at least a portion of both the anode and the cathode, wherein the anode, cathode, and non-fibrous separator are at least partially immersed in the acid. The anode comprises an electrically conductive carbon active material, the cathode comprises a lead oxide active material, and the non-fibrous separator has a thickness of about 0.005 to about 1.5 mm, preferably about 0.1 to about 0.3 mm.

In another aspect, an electrode assembly comprises an anode, a cathode, and a non-fibrous separator disposed between and in contact with at least a portion of both the anode and the cathode. The anode comprises an electrically conductive carbon active material, the cathode comprises a lead oxide active material, and the non-fibrous separator has a thickness of about 0.005 to about 1.5 mm, preferably about 0.1 to about 0.3 mm.

The above described and other features are exemplified by the following figures, detailed description, and claims.

### BRIEF DESCRIPTION OF THE DRAWINGS

The following Figures are exemplary aspects, which are provided to illustrate the present disclosure. The Figures that are illustrative of the examples are not intended to limit devices made in accordance with the disclosure to the materials, conditions, or process parameters set forth herein.

FIG. 1 illustrates a prior art cathode, AGM separator, anode assembly;

FIG. 2 illustrates an aspect of a separator according to the present disclosure disposed between a cathode and an anode;

FIG. 3 is an illustration of a lead carbon battery; and

FIG. 4 shows estimated cell energy and cell porosity for a lead carbon battery cell design with different separator thicknesses (including example 1 and 2).

### DETAILED DESCRIPTION

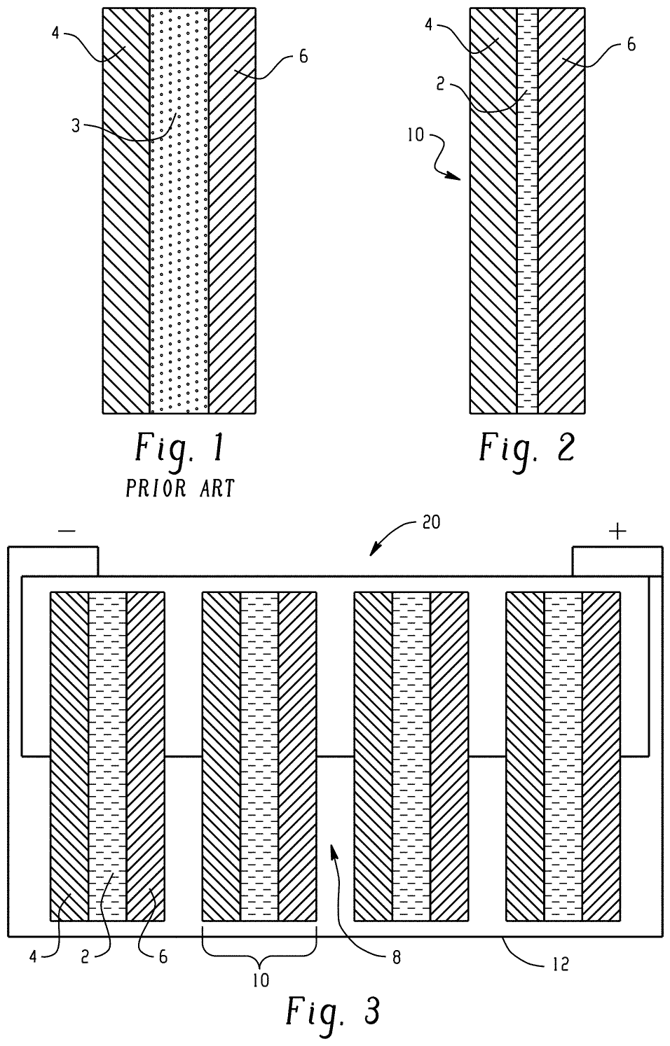

Lead acid and lead carbon batteries include a positive electrode, a negative electrode, a separator, and a liquid electrolyte, generally sulfuric acid, encased in a housing. The separator is disposed between the anode and the cathode to prevent physical contact between the electrodes of opposite polarity while allowing for ionic flow. Batteries that include an electrically conductive carbon active material as an anode typically include a thick, e.g., about 3 millimeters (mm), AGM separator, to provide sufficient electrolyte uptake to provide a working cell. FIG. 1 illustrates a prior art AGM separator 3 disposed between a cathode 4 and an anode 6, the anode 6 including an electrically conductive carbon active material. In order to provide shorter ion diffusion pathways and achieve a higher power density, it is desirable to reduce the thickness of the separator. Reducing the thickness of an AGM separator to 0.3 mm, however, does not provide sufficient absorbed electrolyte to provide a suitable energy and power density for a functional conventional lead acid battery.

As described herein, a rational lead carbon/lead acid battery cell design was developed to utilize the amplified electrolyte uptake in an electrically conductive carbon containing anode together with non-fibrous separators (e.g., polyvinyl chloride (PVC) or polyolefin) that are thinner than conventional AGM separators to improve the cell level energy density and power density. The non-fibrous separators are also referred to as non-AGM separators. The non-fibrous separator 2 is disposed between a cathode 4 and an anode 6, the anode 6 including an electrically conductive carbon active material as shown in the electrode assembly 10 of FIG. 2. The cathode 4, anode 6, and separator 2 can be prepared separately and then stacked to form an electrode assembly 10, with the separator 2 sandwiched between the cathode 4 and anode 6. Alternatively, the cathode 4 or anode 6 can be deposited on the separator 2 such that they are processed together and assembled to form the electrode assembly 10. As shown in the Examples, a prototype battery and its measured electrochemical performance demonstrate feasibility. A battery using the non-fibrous separator of the present disclosure has higher energy and power density compared with a battery utilizing conventional thick AGM separators, while maintaining adequate total cell level electrolyte uptake and similar other performances like spill-proof properties, water retention, and the like.

The non-fibrous separator can be included in a lead acid or lead carbon battery. An example of a lead acid battery is illustrated in FIG. 3. FIG. 3 shows that lead acid battery 20 comprises a sealed casing 12 and an electrode assembly 10 comprising a cathode 4, an anode 6, the anode 6 including an electrically conductive carbon active material. A non-fibrous separator 2 is disposed between the cathode 4 and the anode 6. At least a portion of the electrodes 4, 6 and the non-fibrous separator 2 is immersed in a medium 8, for example an electrolyte comprising sulfuric acid.

The non-fibrous separator comprises a non-fibrous material having a thickness of about 0.005 to about 1.5 mm, preferably about 0.025 to about 0.3 mm.

Exemplary materials for the non-fibrous separator include polymers such as polyvinyl chloride (PVC), a polyolefin, or a non-fibrous glass. Particularly preferred are materials that can be used in a roll-to-roll manufacturing process. Exemplary polyolefins include polyethylene, polypropylene, polytetrafluoroethylenes, ethylene-propylene copolymers, and the like. An exemplary separator is porous. The porous separator can have a porosity of about 30% to about 95%, preferably about 40% to about 90%, more preferably about 50% to about 85%, more preferably about 65% to about 85%, still more preferably about 75%. For example, an exemplary separator comprising PVC has a volume porosity of about 30% to about 95%, preferably about 40% to about 90%, more preferably about 50% to about 85%, more preferably about 65% to about 85%, still more preferably about 75%.

The polymer may also be coated with a ceramic or a polymer, or filled with a particulate ceramic filler such as silica, fumed silica, aluminum oxide, a particulate aerogel, and the like, or a combination thereof.

The anode comprises an electrically conductive carbon active material. The electrically conductive carbon can be one that is electrochemically stable in sulfuric acid. The electrically conductive carbon can comprise activated carbon, template derived carbon, carbide-derived carbon, carbon black, graphite (for example, graphite particles, graphite fibers, or graphite fibrils), carbon nanotubes, carbon nanofibers, graphene, graphene oxide, or a combination thereof. The electrically conductive carbon can comprise a carbon isotope and can offer benefits such as improved electrical conductivity or improved acid resistance. The electrically conductive carbon can be particulate having a D50 particle size by weight of about 0.01 to about 10 micrometers, a BET surface area at least about 50 square meters per gram (m²/g), and preferably at least about 1000 m²/g.

An example of an activated carbon is ELITE-C available from Calgon Carbon LLC, or POWDERED-S available from General Carbon Corporation. Examples of carbon black are SUPER-P from Imersys, VULCAN XC-72 from Cabot Corporation, and SHAWINIGAN BLACK from Chevron Corporation. Examples of carbon nanotubes are those commercially available from Showa Denko K.K. and Bayer AG.

In addition to the electrically conductive carbon active material, the anode can include a binder such as a fluoropolymer, for example a poly(vinylidene fluoride), which provides for formation of an active layer for the anode.

Fluoropolymer as used herein include homopolymers and copolymers that comprise repeat units derived from a fluorinated alpha-olefin monomer, i.e., an alpha-olefin monomer that includes at least one fluorine atom substituent, and optionally, a non-fluorinated, ethylenically unsaturated monomer reactive with the fluorinated alpha-olefin monomer. Exemplary fluorinated alpha-olefin monomers include CF₂═CF₂, CHF═CF₂, CH₂═CF₂, CHCl ═CHF, CClF═CF₂, CCl₂═CF₂, CClF═CClF, CHF═CCl₂, CH₂═CClF, CCl₂═CClF, CF₃CF═CF₂, CF₃CF═CHF, CF₃CH═CF₂, CF₃CH═CH₂, CHF₂CH═CHF, and CF₃CH═CH₂, and perfluoro(C₂₋₈ alkyl)vinylethers such as perfluoromethyl vinyl ether, perfluoropropyl vinyl ether, and perfluorooctylvinyl ether. The fluorinated alpha-olefin monomer can comprise tetrafluoroethylene (CF₂═CF₂), chlorotrifluoroethylene (CClF═CF₂), (perfluorobutyl)ethylene, vinylidene fluoride (CH₂═CF₂), hexafluoropropylene (CF₂═CFCF₃), or a combination thereof. Exemplary non-fluorinated monoethylenically unsaturated monomers include ethylene, propylene, butene, or ethylenically unsaturated aromatic monomers such as styrene or alpha-methyl-styrene. Exemplary fluoropolymers include poly(chlorotrifluoroethylene) (PCTFE), poly(chlorotrifluoroethylene-propylene), poly(ethylene-tetrafluoroethylene) (ETFE), poly(ethylene-chlorotrifluoroethylene) (ECTFE), poly(hexafluoropropylene), poly(tetrafluoroethylene) (PTFE), poly(tetrafluoroethylene-ethylene-propylene), poly(tetrafluoroethylene-hexafluoropropylene) (also known as fluorinated ethylene-propylene copolymer (FEP)), poly(tetrafluoroethylene-propylene) (also known as fluoroelastomer) (FEPM), poly(tetrafluoroethylene-perfluoropropylene vinyl ether), a copolymer having a tetrafluoroethylene backbone with a fully fluorinated alkoxy side chain (also known as a perfluoroalkoxy polymer (PFA)) (for example, poly(tetrafluoroethylene-perfluoroproplyene vinyl ether)), polyvinylfluoride (PVF), polyvinylidene fluoride (PVDF), poly(vinylidene fluoride-chlorotrifluoroethylene), perfluoropolyether, perfluorosulfonic acid, or perfluoropolyoxetane, preferably perfluoroalkoxy alkane polymer, fluorinated ethylene-propylene, or more preferably perfluoroalkoxy alkane polymer. The fluoropolymer can comprise poly(vinylidene fluoride).

The active layer can comprise greater than or equal to about 60 weight percent (wt %), or about 60 to about 99 wt %, or about 75 to about 99 wt % of the activated carbon based on the total weight of the active layer. The active layer can comprise about 1 to about 40 wt %, or about 1 to about 25 wt % of the binder, based on the total weight of the active layer.

The cathode comprises a lead oxide active material, specifically a lead oxide active layer.

The medium of the lead acid or lead carbon battery (the electrolyte) can comprise sulfuric acid, for example, a liquid sulfuric acid. The medium can comprise a gel electrolyte comprising an aqueous sulfuric acid and a thickening agent in an amount sufficient to render the electrolyte a gel. The gel electrolyte can comprise an alkaline earth metal (for example, a silicate, a sulfate, or a phosphate of calcium or strontium. The anode, cathode, and non-fibrous separator can be in direct physical contact with the medium.

In a preferred aspect, a lead carbon battery includes a sealed casing comprising an electrolyte comprising sulfuric acid; and an electrode assembly comprising an anode comprising an electrically conductive carbon active material and a fluoropolymer binder, a cathode comprising a lead oxide active material, and a non-fibrous separator disposed between and in contact with at least a portion of both the anode and the cathode, wherein the anode, cathode, and non-fibrous separator are at least partially immersed in the electrolyte; and wherein the non-fibrous separator comprises a polyvinyl chloride, a polyolefin, a non-fiber glass, or a combination thereof, and has a thickness of about 0.005 to about 1.5 mm, preferably about 0.1 to about 0.3 mm, and a volume porosity of about 30% to about 95%, preferably about 40% to about 90%, more preferably about 50% to about 85%, more preferably about 65% to about 85%, still more preferably about 75%. Preferably, the electrically conductive carbon comprises activated carbon, template-derived carbon, carbide-derived carbon, carbon black, a graphite, carbon nanotubes, carbon nanofibers, graphene, graphene oxide, or a combination thereof. Preferably the fluoropolymer binder comprises a poly(vinylidene fluoride) binder. The lead carbon battery can have a cell density of about 10 to about 90 Watt-hour per kilogram (W-h/kg), a cell porosity of about 10% to about 80%, or a combination thereof.

In another aspect, an electrode assembly includes an anode comprising an electrically conductive carbon active material and fluoropolymer binder; a cathode comprising a lead oxide active material; and a non-fibrous separator disposed between and in contact with at least a portion of both the anode and the cathode, wherein the non-fibrous separator comprises a polyvinyl chloride, a polyolefin, a non-fiber glass, or a combination thereof, and has a thickness of about 0.005 to about 1.5 mm, preferably about 0.1 to about 0.3 mm, and a volume porosity of about 30% to about 95%, preferably about 40% to about 90%, more preferably about 50% to about 85%, more preferably about 65% to about 85%, still more preferably about 75%. Preferably, the electrically conductive carbon comprises activated carbon, template-derived carbon, carbide-derived carbon, carbon black, a graphite, carbon nanotubes, carbon nanofibers, graphene, graphene oxide, or a combination thereof. Preferably the fluoropolymer binder comprises a poly(vinylidene fluoride) binder.

In an aspect, an electrode assembly comprises an electrically conductive carbon active material, a cathode comprising a lead oxide active material, and a non-fibrous PVC or polyolefin separator having a thickness of about 0.005 to about 1.5 mm, preferably about 0.1 to about 0.3 mm, that is disposed between and in contact with at least a portion of both the anode and the cathode. Preferably, the PVC or polyolefin separator is porous, having a volume porosity of about 30% to about 90%.

The assembly described herein can be made by methods such as laminating, printing, and/or a roll-to-roll process, preferably a roll-to-roll process.

The anode-non-fibrous separator-cathode assembly can have a cell level energy density of about 10 to about 90 Watt-hour per kilogram (W-h/kg) a cell porosity of about 10% to about 80%, or both.

Advantageously, the assembly described herein including a non-fibrous mat provides adequate electrolyte uptake. The lead acid or lead carbon battery described herein can have a power density defined as P=V²/4R, where R=ρL/A, R is equivalent series resistance (ESR) of the SC (cell size) ρ is the specific electrical resistance, l is the length of current flow and A is the area of current flow.

The invention is further illustrated by the following non-limiting examples.

### Examples

Examples 1 and 2 are both lead carbon batteries. Example 1 uses a prior art 3 mm AGM separator between the negative active material (NAM) (porous carbonaceous material) and the positive active material (PAM) (lead oxide). Example 2 uses a 300 micrometer (μm) thick PVC having a volume porosity of about 75%.

To test the electrochemical properties of the batteries of Examples 1 and 2, four samples were prepared and tested with a conventional AGM according to Example, 1, and then switched to a about 0.3 mm PVC separator according to Example 2 by disassembling the cell and replacing the separator.

Test Parameters:

Current: C/20, C/5

Charge cut-off: 2.4 volts (V)

Discharge cut-off: 0.8 V

The results are provided in Table 1:

TABLE 1
Cell performance for Example 1 and 2

| | C/20 Energy, |
|---|---|
| Cell ID | Watt-hours (Wh) |
| Cell 1 with 3 mm AGM | 0.50 |
| Cell 2 with 3 mm AGM | 0.66 |
| Cell 1 with 0.3 mm PVC | 0.50 |
| Cell 2 with 0.3 mm PVC | 0.68 |

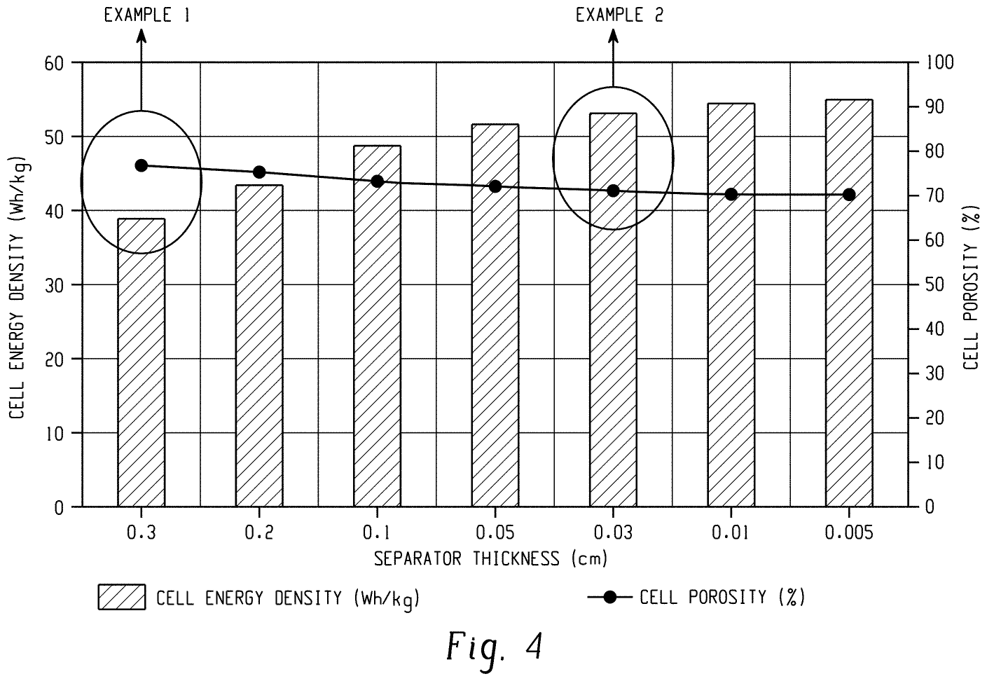

Table 1 shows that switching separators from a conventional 3 mm thick AGM separator to a 0.3 mm non-fibrous separator (e.g., polyvinyl chloride (PVC)) does not significantly impact the electrochemical performance, which is an absolute value of cell energy. This result implies the capacity and cell voltage remains the same, which was predicted since electrochemical performance is predominantly determined by the active material. However, based on a lead acid battery cell design model, with the practical consideration of not only the negative active material (NAM) but also the positive active material (PAM), separator and electrolyte all together, the cell level density was predicted to change significantly with the introduction of a thin non-AGM separator. For example, replacing 3 mm AGM with 0.3 mm PVC with a similar porosity can significantly improve the cell level energy density from 39.06 to 52.97 W-h/kg while maintaining the cell level porosity at about 70% or above. FIG. 4 shows the estimated cell energy and cell porosity for a lead carbon battery cell design with different separator thicknesses (including example 1 and 2). The high cell level porosity ensures adequate total cell level electrolyte uptake even after reducing separator thickness to about 10% or lower than its original thickness. This rational cell design of a lead carbon battery allow lead carbon design to achieve higher dynamic charge acceptance (DCA) and better partial state of charge (PSoC) performances while maintaining similar other performances like spill-proof, water retention, and the like.

Advantageously, the separator design of the current disclosure provides for a higher battery cell level energy and power density compared to conventional AGM separators. Power density is defined as P=V²/4R, where R=ρL/A. Here, R is the equivalent series resistance (ESR) of the SC and p, L, A are the specific electrical resistance, length of current flow and area of current flow, respectively. Thus, a large electrochemically accessible surface area, high electrical conductivity, short ion diffusion pathways are critical to achieve higher power density. Amplification of electrolyte uptake in NAM and decreasing the separator thickness via using a thin non-AGM separator improves the electrolyte accessible surface area and ion diffusion pathway.

Set forth below are non-limiting aspects of the present disclosure.

Aspect 1: A lead acid or lead carbon battery comprising: a sealed casing comprising an acid electrolyte; and an electrode assembly comprising an anode comprising an electrically conductive carbon active material, a cathode comprising a lead oxide active material, and a non-fibrous separator having a thickness of about 0.005 to about 1.5 mm, preferably about 0.1 to about 0.3 mm, and that is disposed between and in contact with at least a portion of both the anode and the cathode, wherein the anode, cathode, and non-fibrous separator are at least partially immersed in the acid electrolyte.

Aspect 2: The lead acid or lead carbon battery of aspect 1, wherein the non-fibrous separator comprises a polyvinyl chloride, a polyolefin, or a non-fiber glass.

Aspect 3: The lead acid or lead carbon battery of aspect 1, wherein the non-fibrous separator comprises a polymer, preferably a polyvinyl chloride, a polyolefin, or a combination thereof, that is coated or filled with a particulate ceramic filler, preferably wherein the ceramic filler is silica, fumed silica, aluminum oxide, or a particulate aerogel.

Aspect 4: The lead acid or lead carbon battery of any of the preceding aspects, wherein the non-fibrous separator is porous and has a volume porosity of about 30-95%, preferably about 75%.

Aspect 5: The lead acid or lead carbon battery of any of the preceding aspects, wherein the electrically conductive carbon comprises activated carbon, template derived carbon, carbide derived carbon, carbon black, a graphite, carbon nanotubes, carbon nanofibers, graphene, graphene oxide, or a combination thereof.

Aspect 6: The lead acid or lead carbon battery of any of the preceding aspects, wherein the anode further comprises a poly(vinylidene fluoride) binder.

Aspect 7: The lead acid or lead carbon battery of any of the preceding aspects, wherein the acid comprises sulfuric acid.

Aspect 8: The lead acid or lead carbon battery of any of the preceding aspects, wherein the electrode assembly has a cell density of about 10 to about 90 W-h/kg and/or a cell porosity of about 10% to about 80%.

Aspect 9: An electrode assembly, comprising an anode comprising an electrically conductive carbon active material, a cathode comprising a lead oxide active material, and a non-fibrous separator having a thickness of about 0.005 to about 1.5 mm, preferably about 0.1 to about 0.3 mm, and that is disposed between and in contact with at least a portion of both the anode and the cathode.

Aspect 10: The electrode assembly of aspect 9, wherein the non-fibrous separator comprises a polyvinyl chloride, a polyolefin, or a non-fiber glass.

Aspect 11: The electrode assembly of any of aspects 9, wherein the non-fibrous separator comprises a polymer, preferably a polyvinyl chloride, a polyolefin, or a combination thereof, coated or filled with a ceramic filler, preferably silica, fumed silica, aluminum oxide, or an aerogel.

Aspect 12: The electrode assembly of any of aspects 9-11, wherein the non-fibrous separator is porous and has a volume porosity of about 30-95%, preferably about 75%.

Aspect 13: The electrode assembly of any of aspects 9-12, wherein the electrically conductive carbon comprises activated carbon, template derived carbon, carbide derived carbon, carbon black, a graphite, carbon nanotubes, carbon nanofibers, graphene, graphene oxide, or a combination thereof.

Aspect 14: The electrode assembly of any of aspects 9-13, wherein the anode further comprises a poly(vinylidene fluoride) binder.

Aspect 15: The electrode assembly of any of aspects 9-14, wherein the electrode assembly has a cell density of about 10 to about 90 W-h/kg and/or a cell porosity of about 10% to about 80%.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced items. The term “or” means “and/or” unless clearly indicated otherwise by context. Reference throughout the specification to “an aspect,” “another aspect,” and so forth, means that a particular element (e.g., feature, structure, step, or characteristic) described in connection with the aspect is included in at least an aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to about 25 wt %, or about 5 to about 20 wt %” is inclusive of the endpoints and all intermediate values of the ranges of “about 5 to about 25 wt %,” such as about 10 to about 23 wt %, etc.). “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or 5% of the stated value. The terms “first,” “second,” and the like, “primary,” “secondary,” and the like, as used herein do not denote any order, quantity, or importance, but rather are used to distinguish one element from another. The term “combination thereof” or “at least one of” means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A lead acid or lead carbon battery comprising:
a sealed casing comprising an acid electrolyte; and
an electrode assembly comprising
an anode comprising an electrically conductive carbon active material,
a cathode comprising a lead oxide active material, and
a non-fibrous separator having a thickness of about 0.005 to about 1.5 mm disposed between and in contact with at least a portion of both the anode and the cathode,
wherein the anode, cathode, and non-fibrous separator are at least partially immersed in the acid electrolyte.

2. The lead acid or lead carbon battery of claim 1, wherein the non-fibrous separator comprises a polyvinyl chloride, a polyolefin, a non-fiber glass, or a combination thereof.

3. The lead acid or lead carbon battery of claim 1, wherein the non-fibrous separator comprises a polymer that is coated or filled with a particulate ceramic filler.

4. The lead acid or lead carbon battery of claim 1, wherein the non-fibrous separator is porous and has a volume porosity of about 30% to about 95%.

5. The lead acid or lead carbon battery of claim 1, wherein the electrically conductive carbon comprises activated carbon, template derived carbon, carbide derived carbon, carbon black, a graphite, carbon nanotubes, carbon nanofibers, graphene, graphene oxide, or a combination thereof.

6. The lead acid or lead carbon battery of claim 1, wherein the anode further comprises a poly(vinylidene fluoride) binder.

7. The lead acid or lead carbon battery of claim 1, wherein the acid comprises sulfuric acid.

8. The lead acid or lead carbon battery of claim 1, wherein the electrode assembly has a cell density of about 10 to about 90 W-h/kg, a cell porosity of about 10% to about 80%, or a combination thereof.

9. An electrode assembly, comprising
an anode comprising an electrically conductive carbon active material,
a cathode comprising a lead oxide active material, and a
non-fibrous separator having a thickness of about 0.005 to about 1.5 mm and disposed between and in contact with at least a portion of both the anode and the cathode.

10. The electrode assembly of claim 9, wherein the non-fibrous separator comprises a polyvinyl chloride, a polyolefin, or a non-fiber glass.

11. The electrode assembly of claim 9, wherein the non-fibrous separator comprises a polymer coated or filled with a ceramic filler.

12. The electrode assembly of claim 9, wherein the non-fibrous separator is porous and has a volume porosity of about 30% to about 95%.

13. The electrode assembly of claim 9, wherein the electrically conductive carbon comprises activated carbon, template derived carbon, carbide derived carbon, carbon black, a graphite, carbon nanotubes, carbon nanofibers, graphene, graphene oxide, or a combination thereof.

14. The electrode assembly of claim 9, wherein the anode further comprises a poly(vinylidene fluoride) binder.

15. The electrode assembly of claim 9, wherein the electrode assembly has a cell density of about 10 to about 90 W-h/kg, a cell porosity of about 10% to about 80%, or a combination thereof.
